(19) United States
(12) Patent Application Publication
(10) Pub. No.: US 2024/0414489 A1
(43) Pub. Date: Dec. 12, 2024

(54) DIRECTIONAL VEHICLE NOTIFICATIONS USING PRE-RENDERED MULTIDIMENSIONAL SOUNDS

(71) Applicant: Atieva, Inc., Newark, CA (US)

(72) Inventors: Antonios Karalis, Palo Alto, CA (US); Peter J. Andrews, Hayward, CA (US); Arvind Agrawal, San Jose, CA (US)

(21) Appl. No.: 18/720,190

(22) PCT Filed: Dec. 14, 2022
(86) PCT No.: PCT/US2022/081583

§ 371 Date: Jun. 14, 2024

Related U.S. Application Data
(60) Provisional application No. 63/265,448, filed on Dec. 15, 2021.

(51) Int. Cl. H04S 3/00; H04R 3/12

(52) U.S. Cl. CPC H04S 3/008; H04R 3/12; H04R 2499/13; H04S 2400/11

(57) ABSTRACT

A method of generating a multidimensional audio notification in a vehicle comprises: registering, in a vehicle having an audio system with multiple channels, an event for which a directional notification is to be generated; obtaining, from among multiple pre-rendered multidimensional sounds in a storage, a first pre-rendered multidimensional sound that is assigned to the event, the first pre-rendered multidimensional sound including audio for more than one of the multiple channels; and playing the obtained first pre-rendered multidimensional sound using the audio system.

### CROSS-REFERENCE TO RELATED APPLICATION

This application claims priority to U.S. Patent Application No. 63/265,448, filed on Dec. 15, 2021, and entitled “DIRECTIONAL VEHICLE NOTIFICATIONS USING PRE-RENDERED MULTIDIMENSIONAL SOUNDS,” the disclosure of which is incorporated by reference herein in its entirety.

### TECHNICAL FIELD

This disclosure relates to directional vehicle notifications generated using pre-rendered multidimensional sounds.

### BACKGROUND

Vehicles have always had one or more ways of signaling a confirmation, condition or occurrence to the driver. The greater complexity of vehicles that has developed in tandem with the increasing incorporation of computer resources introduces new possibilities for more sophisticated forms of communication, including in the failed of vehicle audio systems. However, every use of computing power within a vehicle reduces the amount of resources available for other processes and functions.

### SUMMARY

In an aspect, a method of generating a multidimensional audio notification in a vehicle comprises: registering, in a vehicle having an audio system with multiple channels, an event for which a directional notification is to be generated; obtaining, from among multiple pre-rendered multidimensional sounds in a storage, a first pre-rendered multidimensional sound that is assigned to the event, the first pre-rendered multidimensional sound including audio for more than one of the multiple channels; and playing the obtained first pre-rendered multidimensional sound using the audio system.

Implementations can include any or all of the following features. The first pre-rendered multidimensional sound includes a first sound for all of the multiple channels, and a second sound for fewer than all of the multiple channels, and wherein the first and second sounds are played separately from each other in time. Playing the obtained first pre-rendered multidimensional sound comprises playing the first sound before the second sound. The event reflects a circumstance within a passenger cabin of the vehicle. The obtained first pre-rendered multidimensional sound comprises a seatbelt reminder, and wherein the multiple pre-rendered multidimensional sounds in the storage include multiple seatbelt reminders corresponding to different locations within the passenger cabin, respectively. The obtained first pre-rendered multidimensional sound has one of a front left directionality or a front right directionality, and wherein a second pre-rendered multidimensional sound among the multiple pre-rendered multidimensional sounds has another of the front left directionality or the front right directionality. The first and second pre-rendered multidimensional sounds comprise turn signal notifications. The obtained first pre-rendered multidimensional sound comprises a seatbelt reminder.

### BRIEF DESCRIPTION OF DRAWINGS

FIG. 1 schematically shows an example of a vehicle that can play pre-rendered multidimensional sounds for directional notifications.

FIG. 2 shows an example of a vehicle audio system having pre-rendered multidimensional sounds.

FIG. 3 schematically shows an example of a multichannel audio system and a pre-rendered multidimensional sound.

FIG. 4 illustrates an example architecture of a computer system.

Like reference symbols or numerals in the various drawings indicate like elements.

### DETAILED DESCRIPTION

The present disclosure gives examples of systems and techniques that can play pre-rendered multidimensional sounds for directional notifications in a vehicle. The pre-rendered multidimensional sounds can provide an occupant with an immersive experience relating to one or more kinds of notifications (including, but not limited to, confirmations, announcements, notices, reminders, alerts, warnings, and/or alarms). Moreover, the immersive experience can be provided while subjecting a central processing unit (CPU) to only a relatively low load. For example, this can ensure that CPU cycles are not spent rendering the multidimensional sounds in real time to provide a more efficient use of the vehicle's computer system resources. In some implementations, a turn signal sound, a seatbelt reminder, and/or an advanced driver-assistance system (ADAS) notification can be generated using a pre-rendered multidimensional sound.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether or to what extent the person is driving the vehicle, or whether the person has access to all or only some of the controls for driving the vehicle, or whether the person lacks controls for driving the vehicle.

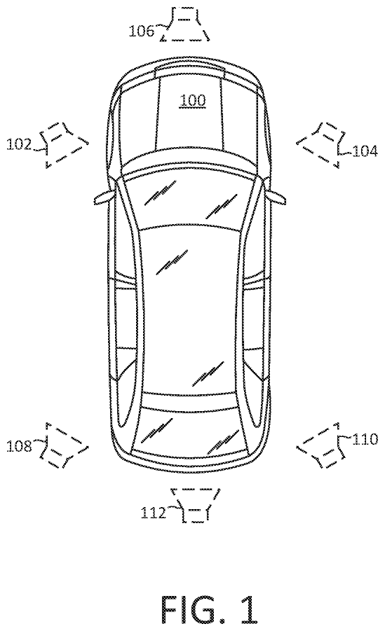

FIG. 1 schematically shows an example of a vehicle 100 that can play pre-rendered multidimensional sounds for directional notifications. The vehicle 100 is here shown in a top view. The vehicle 100 includes a multichannel audio system (e.g., as exemplified below) that can provide an occupant with an immersive audio experience. In some implementations, the vehicle 100 can register events and generate corresponding notifications to one or more occupants using pre-rendered multidimensional sounds.

The immersive experience can be generated by playing at least one pre-rendered multidimensional sound that appears to originate from one or more locations. That is, while the sound is generated by one or more physical speakers of the vehicle 100, it can appear to the occupant as if the sound is arriving from any arbitrary direction relative to the occupant's position in the vehicle 100, due to the audio output of one or more speakers (e.g., two or more speakers playing simultaneously). Any direction can be used. Here, apparent origins 102-112 for any pre-rendered multidimensional sound are schematically shown for purposes of illustration. That is, the apparent origins 102-112 are here positioned outside the vehicle 100 and do not represent locations of physical speakers in the vehicle 100. Rather, the apparent origins 102-112 illustrate examples of the directions from which the occupant can perceive sound as arriving. For example, the apparent origin 102 can be characterized as a front left location, the apparent origin 104 can be characterized as a front right location, and the apparent origin 106 can be characterized as a front center location. As another example, the apparent origin 108 can be characterized as a rear left location, the apparent origin 110 can be characterized as a rear right location, and the apparent origin 112 can be characterized as a rear center location. Other apparent directions can be used.

An immersive experience based on a pre-rendered multidimensional sound can be provided in response to registering any of multiple events for which directional notifications are to be generated. That is, at least one pre-rendered multidimensional sound can be assigned to such an event. The event can reflect a circumstance inside or outside a passenger cabin of the vehicle 100. Circumstances inside the cabin can include that a seatbelt is not fastened at a seat that is currently occupied. The directional notification for a seatbelt reminder can then at least in part be generated from a direction of the non-belted seat. For example, if the passenger sitting in the left position of the rear seat has not fastened their seatbelt, a pre-rendered multidimensional sound can be played that at least in part appears to arrive from the apparent origin 108. The vehicle 100 can be provided with multiple pre-rendered multidimensional sounds comprising seatbelt reminders corresponding to different respective locations within the passenger cabin. As such, when a particular occupied seat is registered as not having its seatbelt fastened, the vehicle 100 can obtain the pre-rendered multidimensional sound corresponding to the seatbelt reminder for that specific location in the vehicle.

The directionality of the immersive experience can be useful in multiple ways. First, the pre-rendered multidimensional sound can, due to its apparent origin, be more immediately noticeable to the unbelted occupant than to other occupants and thereby more immediately gather the unbelted occupant's attention. Second, the pre-rendered multidimensional sound can indicate to someone other than the unbelted occupant (e.g., to a driver), that the unbelted occupant (e.g., a child) may need help in fastening the seatbelt. Third, the pre-rendered multidimensional sound can indicate to someone seated in the front seat that a person in the rear seat does not have their seatbelt fastened.

The dimensionality of the immersive experience can vary during playback of the pre-rendered multidimensional sound. In some implementations, the pre-rendered multidimensional sound can include both a general notification and a directional notification. The general notification and the directional notification can be played separately from each other in time. The general notification can be heard equally throughout the passenger cabin and may not appear to originate only at a specific location (e.g., it can be associated with most or all of the apparent origins 102-112). As such, the general notification can include a sound for all of the multiple channels of the audio system. The directional notification, moreover, can appear to originate at a specific location (e.g., one of the apparent origins 102-112). As such, the directional notification can include a sound for fewer than all of the multiple channels. The general notification and the directional notification can occur in any order. In some implementations, the general notification is played before the directional notification. For example, the general notification can serve to alert all occupants that an event has been detected (including, but not limited to, an unfastened seatbelt), and the directional notification can identify the location at issue.

In some implementations, the event that triggers the immersive audio experience can include activation of a turn signal in the vehicle 100. With a turn signal, the directional notification can primarily indicate to an occupant whether it is the left or right blinker that is flashing. The turn signal activation can be done manually by a driver, or automatically by the vehicle 100 (e.g., by an ADAS that may be partially or fully controlling the motion).

The vehicle 100 can be provided with at least two pre-rendered multidimensional sounds for turn signal notifications: one for a left signal and one for a right signal. That is, one of these pre-rendered multidimensional sounds has a front left directionality (e.g., associated with the apparent origin 102) and the other of these pre-rendered multidimensional sounds has a front right directionality (e.g., associated with the apparent origin 104). Upon registering activation of the turn signal the vehicle 100 can obtain the corresponding pre-rendered multidimensional sound (e.g., left turn or right turn) from a storage, and play it over the multichannel audio system. That is, the pre-rendered multidimensional sound that the vehicle 100 obtains in response to a turn signal activation event has one of a front left directionality or a front right directionality; the other one of these pre-rendered multidimensional sounds has another of the front left directionality or the front right directionality.

The pre-rendering can include that the sound is biased in either the left or the right direction. For example, the main sound can come from a nearest channel (e.g., the front left or front right channel, respectively), and there may be reverberation tails that appear in other channels than where the main sound is played. Other approaches can be used.

The event that triggers the immersive audio experience can relate to an occurrence outside of the vehicle 100 itself. In some implementations, an ADAS can detect one or more events that can be the basis for generating a pre-rendered multidimensional sound, and the sound can then appear to originate from the direction of the occurrence. For example, the ADAS can issue an alert upon the vehicle 100 driving towards an obstacle, and/or in response to another vehicle driving toward the vehicle 100.

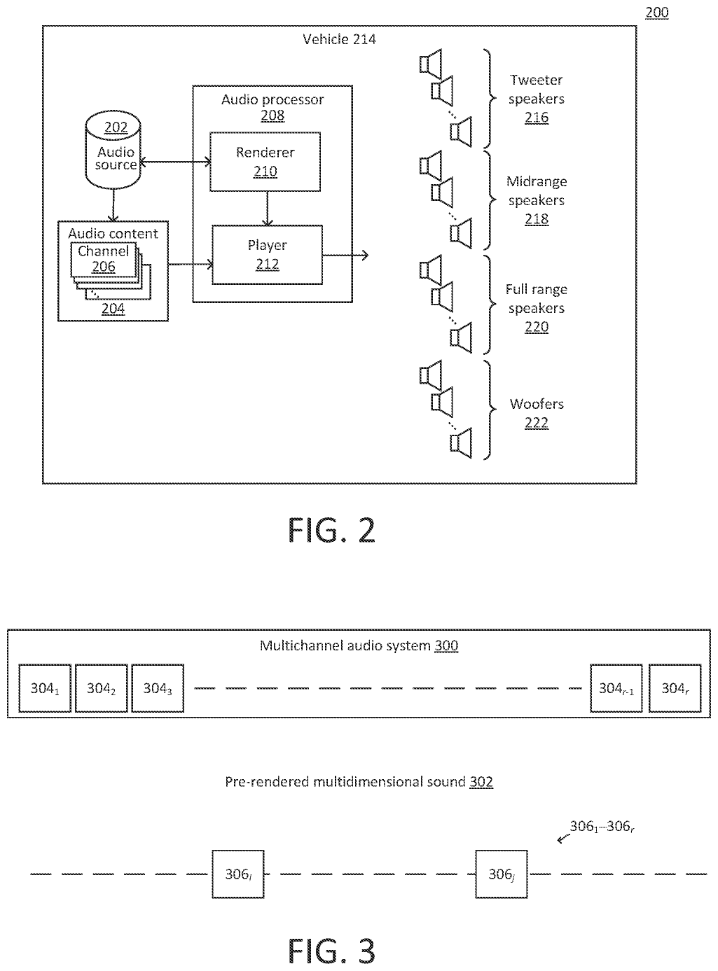

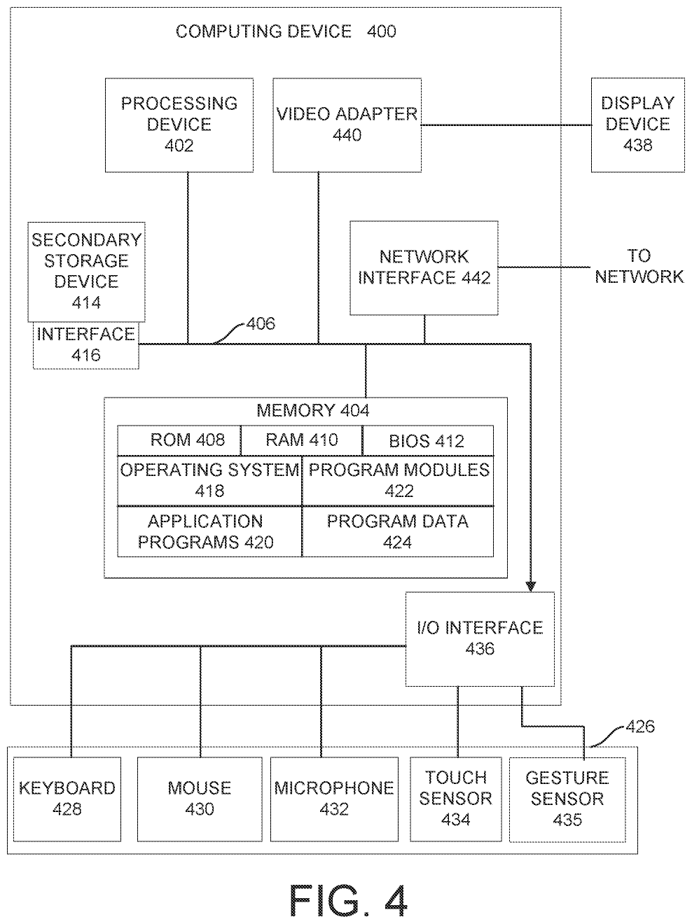

FIG. 2 shows an example of a vehicle audio system 200 having pre-rendered multidimensional sounds. The vehicle audio system 200 can be used with one or more other examples described elsewhere herein. The vehicle audio system 200 can be implemented using some or all examples described below with reference to FIG. 4.

The vehicle audio system 200 includes at least one audio source 202. The audio source 202 can be local to the vehicle (e.g., a local hard drive, memory, or other audio storage device) and here includes at least multiple pre-rendered multidimensional sounds. Here, audio content 204 from the audio source 202 represents one or more of the pre-rendered multidimensional sounds and is schematically shown as including channels 206 of audio information. Any number of channels can be used.

The vehicle audio system 200 can include an audio processor 208 that can receive or obtain from the audio source 202 the audio content 204 having the channels 206. The audio processor 208 includes a renderer 210 that can be used when playing audio content that has not yet been rendered. As such, the renderer 210 can mix sounds into one or more of the available channels. For example, the renderer can pan sounds between different channels. The renderer 210 can be used for the pre-rendering of the sounds to be stored in the audio source 202, or the sounds of the audio source 202 can be pre-rendered using another renderer.

The audio processor 208 includes a player 212 that can provide audio content of the multiple channels to one or more speakers to be played. When the renderer 210 is rendering content, the player 212 can receive the rendered content from the renderer 210. However, the pre-rendered multidimensional sounds of the audio source 202 can bypass the renderer 210. In some implementations, the pre-rendered multidimensional sounds are pre-panned and pre-mixed among the available channels of the audio system. For example, the player 212 can then obtain the pre-rendered multidimensional sounds directly from the audio source 202 without using the renderer 210. This can avoid using CPU resources for rendering (e.g., mixing and panning) these sounds every time they are to be played. Rather, a sound that has already been properly spatialized can be called up and played without devoting computer resources toward rendering it.

At least the audio processor 208 can be implemented in a vehicle 214, as schematically indicated. The vehicle 214 includes speakers for playing audio, including, but not limited to, pre-rendered directional notifications. One or more types of speaker types can be used, including, but not limited to, tweeter speakers, midrange speakers, full range speakers, and/or woofers. Each speaker (type) can include one or more transducers (e.g., a voice coil) for converting an electric input to sound waves. The vehicle 214 can include n number of tweeter speakers 216 that can have any of multiple arrangements within the vehicle 214. The vehicle 214 can include m number of midrange speakers 218 that can have any of multiple arrangements within the vehicle 214. The vehicle 214 can include p number of full range speakers 220 (sometimes referred to as twiddler speakers) that can have any of multiple arrangements within the vehicle 214. The vehicle 214 can include q number of woofers 222 (e.g., subwoofers) that can have any of multiple arrangements within the vehicle 214. Other approaches can be used.

FIG. 3 schematically shows an example of a multichannel audio system 300 and a pre-rendered multidimensional sound 302. The multichannel audio system 300 and/or the pre-rendered multidimensional sound 302 can be used with one or more other examples described elsewhere herein. The multichannel audio system 300 is here schematically shown as having r number of channels 304₁, 304₂, 304₃, . . . 304ᵣ₋₁, 304ᵣ, where r >1. In playback, each of the channels 304₁-304ᵣ can be provided to one or more of the speakers (not shown) of the multichannel audio system 300.

The pre-rendered multidimensional sound 302 can include r number of components 306₁-306ᵣ. When any of the components 306₁-306ᵣ is nonzero, the pre-rendered multidimensional sound 302 generates a sound in the one of the channels 304₁-304ᵣ corresponding to that component. The length of the sound being played, and/or its timing relative to another sound of the pre-rendered multidimensional sound 302, can differ between the components 306₁-306ᵣ. Here, the two outermost nonzero components of the components 306₁-306ᵣ are components 306i and 306j, where

$$\begin{matrix}1 \leq i < j , and \\ i < j \leq r .\end{matrix}$$

Between the components 306i and 306j, the pre-rendered multidimensional sound 302 can include zero or more other nonzero components. As such, the pre-rendered multidimensional sound 302 is multidimensional because at least two of the components 306₁-306ᵣ are nonzero.

FIG. 4 illustrates an example architecture of a computing device 400 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 4 can be used to execute the operating system, application programs, and/or software modules (including the software engines) described herein.

The computing device 400 includes, in some embodiments, at least one processing device 402 (e.g., a processor), such as a central processing unit (CPU). A variety of processing devices are available from a variety of manufacturers, for example, Intel or Advanced Micro Devices. In this example, the computing device 400 also includes a system memory 404, and a system bus 406 that couples various system components including the system memory 404 to the processing device 402. The system bus 406 is one of any number of types of bus structures that can be used, including, but not limited to, a memory bus, or memory controller; a peripheral bus; and a local bus using any of a variety of bus architectures.

Examples of computing devices that can be implemented using the computing device 400 include a desktop computer, a laptop computer, a tablet computer, a mobile computing device (such as a smart phone, a touchpad mobile digital device, or other mobile devices), or other devices configured to process digital instructions.

The system memory 404 includes read only memory 408 and random access memory 410. A basic input/output system 412 containing the basic routines that act to transfer information within computing device 400, such as during start up, can be stored in the read only memory 408.

The computing device 400 also includes a secondary storage device 414 in some embodiments, such as a hard disk drive, for storing digital data. The secondary storage device 414 is connected to the system bus 406 by a secondary storage interface 416. The secondary storage device 414 and its associated computer readable media provide nonvolatile and non-transitory storage of computer readable instructions (including application programs and program modules), data structures, and other data for the computing device 400.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 414 and/or system memory 404, including an operating system 418, one or more application programs 420, other program modules 422 (such as the software engines described herein), and program data 424. The computing device 400 can utilize any suitable operating system.

In some embodiments, a user provides inputs to the computing device 400 through one or more input devices 426. Examples of input devices 426 include a keyboard 428, mouse 430, microphone 432 (e.g., for voice and/or other audio input), touch sensor 434 (such as a touchpad or touch sensitive display), and gesture sensor 435 (e.g., for gestural input). In some implementations, the input device(s) 426 provide detection based on presence, proximity, and/or motion. Other embodiments include other input devices 426. The input devices can be connected to the processing device 402 through an input/output interface 436 that is coupled to the system bus 406. These input devices 426 can be connected by any number of input/output interfaces, such as a parallel port, serial port, game port, or a universal serial bus. Wireless communication between input devices 426 and the input/output interface 436 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 438, such as a monitor, liquid crystal display device, light-emitting diode display device, projector, or touch sensitive display device, is also connected to the system bus 406 via an interface, such as a video adapter 440. In addition to the display device 438, the computing device 400 can include various other peripheral devices (not shown), such as speakers or a printer.

The computing device 400 can be connected to one or more networks through a network interface 442. The network interface 442 can provide for wired and/or wireless communication. In some implementations, the network interface 442 can include one or more antennas for transmitting and/or receiving wireless signals. When used in a local area networking environment or a wide area networking environment (such as the Internet), the network interface 442 can include an Ethernet interface. Other possible embodiments use other communication devices. For example, some embodiments of the computing device 400 include a modem for communicating across the network.

The computing device 400 can include at least some form of computer readable media. Computer readable media includes any available media that can be accessed by the computing device 400. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 400.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 4 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 400 can be characterized as an ADAS computer. For example, the computing device 400 can include one or more components sometimes used for processing tasks that occur in the field of artificial intelligence (AI). The computing device 400 then includes sufficient proceeding power and necessary support architecture for the demands of ADAS or AI in general. For example, the processing device 402 can include a multicore architecture. As another example, the computing device 400 can include one or more co-processors in addition to, or as part of, the processing device 402. In some implementations, at least one hardware accelerator can be coupled to the system bus 406. For example, a graphics processing unit can be used. In some implementations, the computing device 400 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method of generating a multidimensional audio notification in a vehicle, the method comprising:
registering, in a vehicle having an audio system with multiple channels, an event for which a directional notification is to be generated;
obtaining, from among multiple pre-rendered multidimensional sounds in a storage, a first pre-rendered multidimensional sound that is assigned to the event, the first pre-rendered multidimensional sound including audio for more than one of the multiple channels; and
playing the obtained first pre-rendered multidimensional sound using the audio system.

2. The method of claim 1, wherein the first pre-rendered multidimensional sound includes a first sound for all of the multiple channels, and a second sound for fewer than all of the multiple channels, and wherein the first and second sounds are played separately from each other in time.

3. The method of claim 2, wherein playing the obtained first pre-rendered multidimensional sound comprises playing the first sound before the second sound.

4. The method of claim 2, wherein the event reflects a circumstance within a passenger cabin of the vehicle.

5. The method of claim 4, wherein the obtained first pre-rendered multidimensional sound comprises a seatbelt reminder, and wherein the multiple pre-rendered multidimensional sounds in the storage include multiple seatbelt reminders corresponding to different locations within the passenger cabin, respectively.

6. The method of claim 1, wherein the obtained first pre-rendered multidimensional sound has one of a front left directionality or a front right directionality, and wherein a second pre-rendered multidimensional sound among the multiple pre-rendered multidimensional sounds has another of the front left directionality or the front right directionality.

7. The method of claim 6, wherein the first and second pre-rendered multidimensional sounds comprise turn signal notifications.

8. The method of claim 1, wherein the obtained first pre-rendered multidimensional sound comprises a seatbelt reminder.
